(19) United States
(12) Patent Application Publication
(10) Pub. No.: US 2016/0370555 A1
(43) Pub. Date: Dec. 22, 2016

(54) COLOR FILTER SUBSTRATE AND MANUFACTURING METHOD THEREOF, DISPLAY DEVICE AND MANUFACTURING METHOD THEREOF

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Haiyun LIN, Beijing (CN); Qinghui ZHAO, Beijing (CN); Jingpeng LI, Beijing (CN); Dongchao LI, Beijing (CN)

(21) Appl. No.: 15/145,217

(22) Filed: May 3, 2016

(30) Foreign Application Priority Data
Jun. 17, 2015 (CN) 201510338639.5

(51) Int. Cl. G02B 7/00; G02B 5/00

(52) U.S. Cl. CPC G02B 7/006; G02B 5/003

(57) ABSTRACT

Embodiments of the present disclosure provide a color filter substrate and a manufacturing method thereof, and a display device and a manufacturing method thereof. The color filter substrate comprises a black light-shielding layer, and the black light-shielding layer is arranged in at least one of regions except a sealant region of the color filter substrate.

### TECHNICAL FIELD

Embodiments of the present disclosure relate to a color filter substrate and a manufacturing method thereof, and a display device and a manufacturing method thereof.

### BACKGROUND

A Liquid Crystal Display (LCD) is widely used in a display field. The LCD generally includes a color filter substrate and an array substrate cell-assembled, and liquid crystal and a sealant which are located between the array substrate and the color filter substrate. In the prior art, the color filter substrate and the array substrate are bonded by the sealant, and then the sealant is cured by ultraviolet light, to cell-assemble the color filter substrate and the array substrate.

However, due to technical limitations, at present, the sealant can not be completely cured, thus affecting a cell-assembling effect of the color filter substrate and the array substrate, further affecting a display effect of a display device.

### SUMMARY

Embodiments of the present disclosure provide a color filter substrate and a manufacturing method thereof, and a display device and a manufacturing method thereof, for providing a structure in which all of a sealant can be irradiated, so that the sealant is completely cured, thus making a cell-assembled effect of the color filter substrate and the array substrate better.

In one aspect, an embodiment of the present disclosure provides a color filter substrate, comprising: a black light-shielding layer, the black light-shielding layer being arranged in at least one of regions except a sealant region of the color filter substrate.

In another aspect, an embodiment of the present disclosure provides a display device comprising the color filter substrate as mentioned above.

In still another aspect, an embodiment of the present disclosure provides a manufacturing method of a color filter substrate, comprising: coating a material film for forming a black light-shielding layer on a base substrate; and forming a pattern including the black light-shielding layer by a patterning process, the black light-shielding layer being arranged in at least one of regions except a sealant region of the color filter substrate.

In still another aspect, an embodiment of the present disclosure provides a manufacturing method of a display device comprising the manufacturing method of the color filter substrate as mentioned above.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1 is an exemplary cross-sectional diagram of a display device;

FIG. 2 is a structural schematic diagram of a display device provided by an embodiment of the present disclosure;

FIG. 3 is a schematic diagram of curing a sealant of the display device in FIG. 2:

FIG. 4 is a structural schematic diagram of another display device provided by an embodiment of the present disclosure;

FIG. 5 is a structural schematic diagram of a black light-shielding layer provided by an embodiment of the present disclosure;

FIG. 6 is a structural schematic diagram of another display device provided by an embodiment of the present disclosure;

FIG. 7 is a flow chart of a manufacturing method of a display device provided by an embodiment of the present disclosure; and

FIG. 8 is a flow chart of a manufacturing method of another display device provided by an embodiment of the present disclosure.

### DETAILED DESCRIPTION

In order to make objects, technical details and advantages of the embodiments of the invention apparent, the technical solutions of the embodiment will be described in a clearly and fully understandable way in connection with the drawings related to the embodiments of the invention. It is obvious that the described embodiments are just a part but not all of the embodiments of the invention. Based on the described embodiments herein, those skilled in the art can obtain other embodiment(s), without any inventive work, which should be within the scope of the invention.

In a description of embodiments of the present disclosure, it should be noted that, azimuth or positional relationships indicated by terms such as “up”, “down” ,“inside”, “outside” and so on, are based on the azimuth or positional relationships shown in the drawings, which are only to facilitate description of the present disclosure and simplify the description, but not to indicate or imply that the device or components must have a specific azimuth, or be constructed or operated in the specific azimuth, which thus cannot be understood as a limitation to the present disclosure.

### A First Embodiment

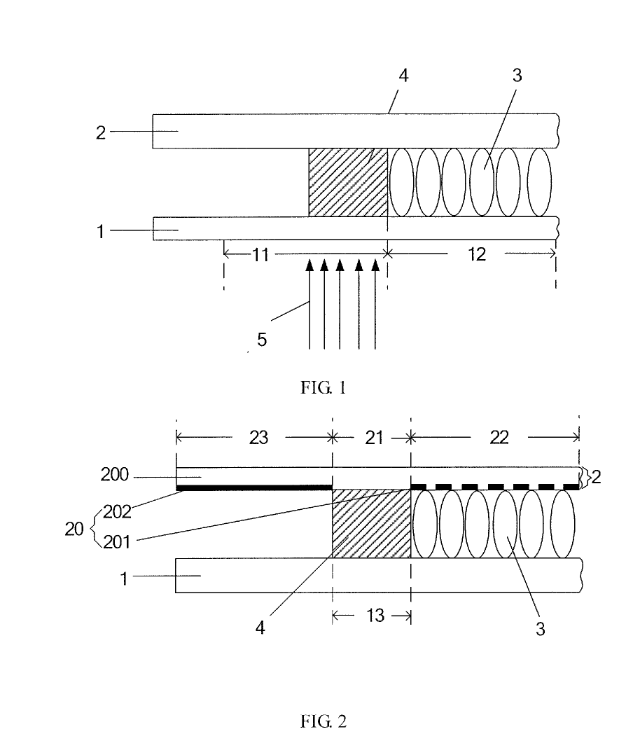

The embodiment of the present disclosure provides a color filter substrate; referring to FIG. 2, the color filter substrate 2 comprises a black light-shielding layer 20, and the black light-shielding layer 20 is arranged in at least one of regions except a sealant region 21 of the color filter substrate 2.

In the color filter substrate described above, the regions except the sealant region refer to all other regions except the sealant region in the color filter substrate, the all other regions may include a display region 22 and an edge region 23 as shown in FIG. 2, and of course, may further include any other region, which is not limited here; and in addition, the black light-shielding layer is arranged in at least one of the regions except a sealant region of the color filter substrate, which indicates that the black light-shielding layer may be only arranged in one region of the all other regions, for example, the display region 22 shown in FIG. 2, or may be arranged in two or more regions of the all other regions, for example, the display region 22 and the edge region 23 shown in FIG. 2, which is not specifically limited here and subjected to actual situations. Of course, in order to prevent light emitted by respective pixels from mutual interference and light leakage, the display region may be provided with a black light-shielding layer.

In the color filter substrate described above, a material of the black light-shielding layer is not limited by an embodiment of the present disclosure; the black light-shielding layer may be made of organic material, for example, may be made of a black resin material, of course, may be further made of any other material, for example, may be made of a black inorganic ink material, which is not specifically limited here.

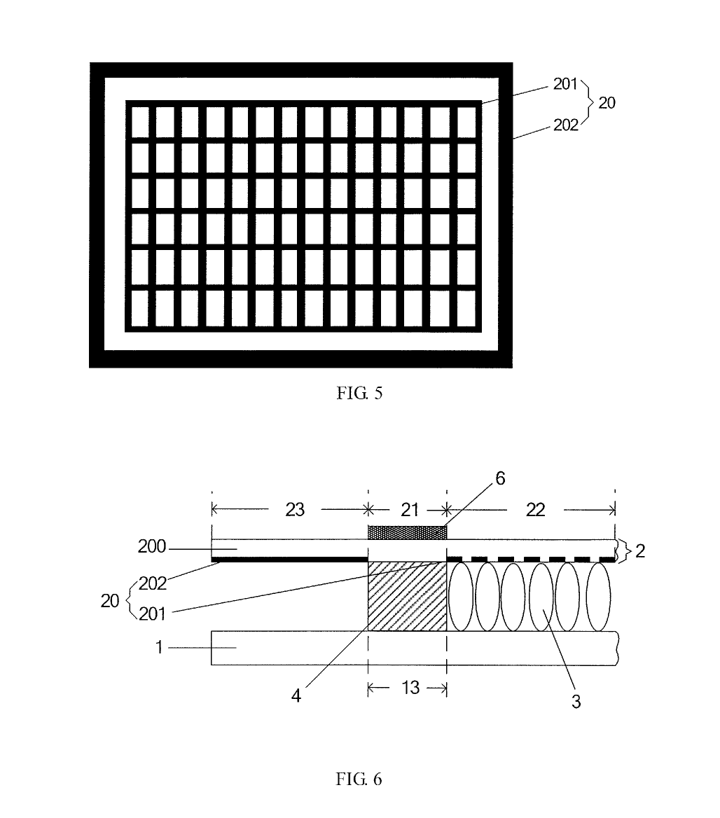

In the color filter substrate described above, a pattern of the black light-shielding layer is not specifically limited by an embodiment of the present disclosure. Exemplarily, the black light-shielding layer may be formed as a net-like shape, to form a black matrix; and of course, may continuously cover a region for coating a layer, which is not specifically limited here. Referring to FIG. 5, the black light-shielding layer in the display region of the color filter substrate is in a net-like shape, so as to form a color filter layer subsequently.

In the color filter substrate described above, in order to realize a color display, the color filter substrate further comprises a color filter layer formed on the black light-shielding layer; the color filter layer may be arranged on the black light-shielding layer in the display region as shown in FIG. 2, to realize filtering of red, green and blue lights, further realizing the color display. Since the color filter substrate and the array substrate are cell-assembled by a sealant, the sealant is located between a sealant region of the color filter substrate and a sealant region of the array substrate; in order to keep consistency in a thickness of cell, the color filter layer may be not formed in the sealant region of the color filter substrate, which is not specifically limited by an embodiment of the present disclosure. The color filter layer may be only formed in the display region of the color filter substrate, so as to reduce cost, meanwhile, to improve light transmittance of the sealant region of the color filter substrate.

Exemplarily, the color filter substrate described above may further comprise a thin film or a layer structure such as an alignment film, which is not specifically limited here and subjected to actual situations, as long as it is ensured that light may be entered from the sealant region of the color filter substrate. For example, the alignment film may be arranged in the display region of the color filter substrate as shown in FIG. 2, and exemplarily, the alignment film may be arranged above the black light-shielding layer.

Referring to FIG. 1, an exemplary LCD includes an array substrate 1 and a color filter substrate 2 which are cell-assembled, and liquid crystal 3 and a sealant 4 which are located between the array substrate 1 and the color filter substrate 2. The array substrate includes a Gate Driver on Array (GOA) region 11 and a display region 12. During curing the sealant 4, ultraviolet light 5 is emitted from a side of the array substrate 1 away from the liquid crystal 3, and irradiate the sealant 4 after passing the GOA region 11 of the array substrate, to cure the sealant 4.

However, for a LCD employed a narrow-frame technology, an aperture ratio of the GOA region of the array substrate is low, in this way, when the sealant is cured by the ultraviolet light, the ultraviolet light may only irradiate a part of the sealant after passing the GOA region, so that the sealant may not be cured completely, thus affecting a cell-assembled effect of the color filter substrate and the array substrate, further affecting a display effect of a display device.

An embodiment of the present disclosure provides a color filter substrate, referring to FIG. 2, a black light-shielding layer 20 is not arranged in a sealant region 21 of the color filter substrate 2, so that light may transmit through the sealant region 21 of the color filter substrate 2; and then, referring to FIG. 3, for a display device comprising the color filter substrate 2, when the sealant is cured, the ultraviolent light 5 may be incident onto the sealant 4 via the sealant region 21 of the color filter substrate 2, so that the sealant 4 is completely cured, thus making a cell-assembled effect of the color filter substrate 2 and the array substrate 1 better.

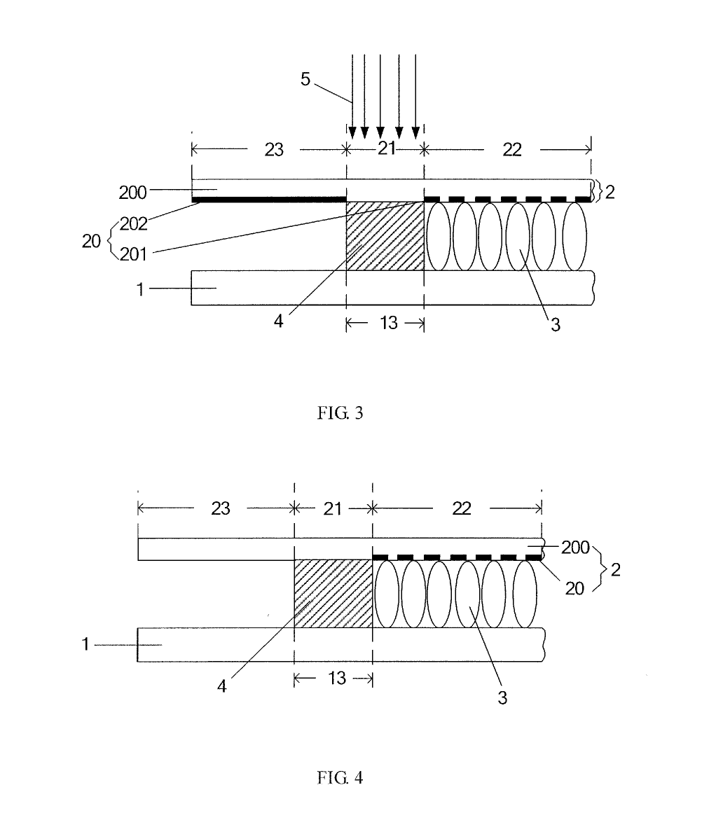

Optionally, referring to FIG. 4, the regions except the sealant region 21 of the color filter substrate 2 include: a display region 22 and an edge region 23; the black light-shielding layer 20 is only arranged in the display region 22, but not arranged in the edge region 23.

It should be noted that, referring to FIG. 4, the display region 22 refers to a region for displaying inside the sealant 4, and the edge region 23 refers to a region for forming a driving circuit and the like outside the sealant 4. The structure shown in FIG. 4 may reduce the black light-shielding layer, so as to reduce cost. Further, the black light-shielding layer 20 in the display region may be in a net-like shape, to facilitate forming a color filter layer subsequently.

Optionally, referring to FIG. 2, the regions except the sealant region 21 of the color filter substrate 2 include: a display region 22 and an edge region 23; the black light-shielding layer 20 includes a first black light-shielding pattern 201 and a second black light-shielding pattern 202; the first black light-shielding pattern 201 is arranged in the display region 22, and the second black light-shielding pattern 202 is arranged in the edge region 23.

It should be noted that, referring to FIG. 2, the display region 22 refers to a region for displaying inside the sealant 4, and the edge region 23 refers to a region for forming a driving circuit and the like outside the sealant 4. In addition, shapes of the first black light-shielding pattern and the second black light-shielding pattern are not limited here and subjected to actual situations.

Exemplarily, referring to FIG. 5, the first black light-shielding layer pattern 201 is in a net-like shape, to facilitate forming a color filter layer subsequently, avoiding light leakage while realizing a color display; the second black light-shielding layer pattern 202 covers the edge region, so as to further prevent the display device comprising the color filter substrate from the light leakage.

### A Second Embodiment

An embodiment of the present disclosure provides a display device, and the display device comprises any color filter substrate provided by the first embodiment. The display device may be a display device, such as a liquid crystal display, e-paper, or any products or parts having display function, such as a TV, a digital camera, a mobile telephone, a tablet computer including the display device. A black light-shielding layer is not arranged in a sealant region of a color filter substrate in the display device, so that light may transmit through the sealant region of the color filter substrate, and for the display device comprising the color filter substrate, when the sealant is cured, the light may irradiate the sealant via the sealant region of the color filter substrate, so that the sealant is completely cured, thus making a cell-assembled effect of the color filter substrate and the array substrate better.

Optionally, referring to FIG. 2, the display device further comprises an array substrate 1 cell-assembled with the color filter substrate 2, the color filter substrate 2 and the array substrate 1 are cell-assembled by a sealant 4, the sealant 4 is located at a position between a sealant region 21 of the color filter substrate 2 and a sealant region 13 of the array substrate 1, and the sealant 4 is nontransparent after curing. If the sealant of the display device is nontransparent after curing, exemplarily, the sealant may be made of red material, or may be made of material of other colors, which is not specifically limited here, as long as the sealant is nontransparent after curing. In this way, the light may be prevented from being emitted from the sealant, further reducing light leakage of the display device, thus improving the display effect.

If the sealant is transparent after curing, in order to prevent the light from being emitted from the sealant, referring to FIG. 6, the display device further comprises an array substrate 1 cell-assembled with the color filter substrate 2, the color filter substrate 2 and the array substrate 1 are cell-assembled by a sealant 4, the sealant 4 is located at a position between a sealant region 21 of the color filter substrate 2 and a sealant region 13 of the array substrate 1, the sealant 4 is transparent after curing, and a light-shielding body 6 is arranged on a side of the sealant region 21 of the color filter substrate 2 away from the array substrate 1.

It should be noted that, the light-shielding body is arranged after the sealant of the display device is cured; the light-shielding body may be a black adhesive tape, or may be any other object for shielding light, which is not specifically limited here, as long as it can play a role of shielding light.

The light-shielding body of the display device described above may prevent the light from being emitted from the sealant, further reducing light leakage of the display device, thus improving the display effect.

### A Third Embodiment

The embodiment of the present disclosure provides a manufacturing method of a color filter substrate, and the color filter substrate formed by using the method may be referred to FIG. 2 and FIG. 4; the method comprises: coating material film for forming a black light-shielding layer 20 on a base substrate 200, and forming a pattern including the black light-shielding layer 20 by a patterning process, the black light-shielding layer 20 being arranged in at least one of regions except a sealant region 21 of the color filter substrate 2.

It should be noted that, the patterning process includes processes such as photoresist coating, exposing, developing, etching, photoresist stripping and so on.

The embodiment of the present disclosure provides a manufacturing method of a color filter substrate, a black light-shielding layer is not arranged in a sealant region of a color filter substrate formed by using the method, so that light may transmit through the sealant region of the color filter substrate, and for the display device comprising the color filter substrate, when the sealant is cured, the light may irradiate the sealant via the sealant region of the color filter substrate, so that the sealant is completely cured, thus making a cell-assembled effect of the color filter substrate and the array substrate better.

Optionally, referring to FIG. 4, the regions except the sealant region 21 of the color filter substrate 2 include: a display region 22 and an edge region 23; the black light-shielding layer 20 is only arranged in the display region 22, but not arranged in the edge region 23.

It should be noted that, referring to FIG. 4, the display region 22 refers to a region for displaying inside the sealant 4, and the edge region 23 refers to a region for forming a driving circuit and the like outside the sealant 4. The structure may reduce the black light-shielding layer, so as to reduce cost. Further, the black light-shielding layer 20 in the display region may be in a net-like shape, to facilitate forming a color filter layer subsequently.

Optionally, referring to FIG. 2, the regions except the sealant region 21 of the color filter substrate 2 include: a display region 22 and an edge region 23; the black light-shielding layer 20 includes a first black light-shielding pattern 201 and a second black light-shielding pattern 202; the first black light-shielding pattern 201 is arranged in the display region 22, and the second black light-shielding pattern 202 is arranged in the edge region 23.

It should be noted that, referring to FIG. 2, the display region 22 refers to a region for displaying inside the sealant 4, and the edge region 23 refers to a region for forming a driving circuit and the like outside the sealant 4. In addition, shapes of the first black light-shielding pattern and the second black light-shielding pattern are not limited here and subjected to actual situations.

Exemplarily, referring to FIG. 5, the first black light-shielding layer pattern 201 is in a net-like shape, to facilitate forming a color filter layer subsequently, avoiding light leakage while realizing a color display; the second black light-shielding layer pattern 202 covers the edge region, so as to further prevent the display device comprising the color filter substrate from the light leakage.

### A Fourth Embodiment

The embodiment of the present disclosure provides a manufacturing method of a display device, and the method comprises any manufacturing method of a color filter substrate provided by the third embodiment.

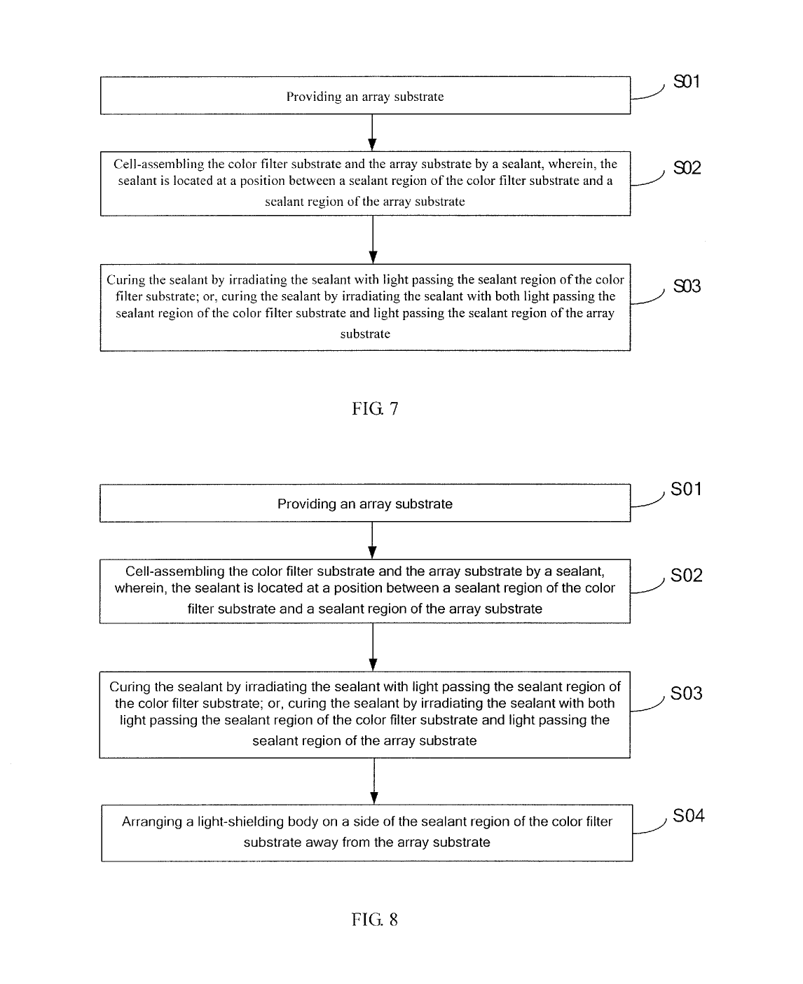

Further optionally, referring to FIG. 7, the method may further comprise:

Step S01: providing an array substrate;

Step S02: cell-assembling the color filter substrate and the array substrate by a sealant, wherein, the sealant is located at a position between a sealant region of the color filter substrate and a sealant region of the array substrate.

Step S03: referring to FIG. 3, curing the sealant 4 by irradiating the sealant 4 with light (it is described by taking an example of the ultraviolet light 5 in FIG. 3) passing the sealant region 21 of the color filter substrate 2; or, curing the sealant by irradiating the sealant with both light passing the sealant region of the color filter substrate and light passing the sealant region of the array substrate (not shown).

It should be noted that, the sealant may be cured by the ultraviolet light in the method described above, and of course, the sealant may be cured by another light, which is not specifically limited here. The embodiments of the present disclosure and accompanying drawings are described by taking an example that the sealant is cured by the ultraviolet light.

An embodiment of the present disclosure provides a manufacturing method of a display device, a black light-shielding layer is not arranged in a sealant region of a color filter substrate of a display device formed by using the method, so that light may transmit through the sealant region of the color filter substrate, and for the display device comprising the color filter substrate, when the sealant is cured, the light may irradiate the sealant via the sealant region of the color filter substrate, so that the sealant is completely cured, or the light may be irradiate the sealant via the sealant region of the color filter substrate and the sealant region of the array substrate, so that the sealant is completely cured, thus making a cell-assembled effect of the color filter substrate and the array substrate better.

Further optionally, referring to FIG. 8, if the sealant is transparent after curing, after step S03 of curing the sealant, the method further comprises:

Step S04: referring to FIG. 6, arranging a light-shielding body 6 on a side of the sealant region 21 of the color filter substrate 2 away from the array substrate 1.

It should be noted that, the light-shielding body may be a black adhesive tape, or may be an other object for shielding light, which is not specifically limited here, as long as the light may be shielded.

In the display device formed by the method described above, the light-shielding body may prevent light from being emitted from the sealant, further reducing light leakage of the display device, thus improving the display effect.

The embodiment of the invention being thus described, it will be obvious that the same may be varied in many ways. Such variations are not to be regarded as a departure from the spirit and scope of the invention, and all such modifications as would be obvious to those skilled in the art are intended to be included within the scope of the following claims.

The present application claims priority of Chinese Patent Application No. 201510338639.5 filed on Jun. 17, 2015, the disclosure of which is incorporated herein by reference in its entirety as part of the present application.

1. A color filter substrate, comprising: a black light-shielding layer, the black light-shielding layer being arranged in at least one of regions except a sealant region of the color filter substrate.

2. The color filter substrate according to claim 1, wherein the regions except the sealant region of the color filter substrate comprise: a display region and an edge region.

3. The color filter substrate according to claim 2, wherein the black light-shielding layer is arranged in the display region or the edge region.

4. The color filter substrate according to claim 2, wherein the black light-shielding layer is arranged in both the display region and the edge region.

5. The color filter substrate according to claim 3, wherein the black light-shielding layer is arranged in the display region and the black light-shielding layer is in a net-like shape.

6. The color filter substrate according to claim 4, wherein the black light-shielding layer includes a first black light-shielding pattern and a second black light-shielding pattern, the first black light-shielding pattern being arranged in the display region, and the second black light-shielding pattern being arranged in the edge region.

7. The color filter substrate according to claim 6, wherein the first black light-shielding pattern is in a net-like shape and the second black light-shielding pattern continuously covers the edge region.

8. A display device, comprising the color filter substrate according to claim 1.

9. The display device according to claim 8, further comprises: an array substrate cell-assembled with the color filter substrate, the color filter substrate and the array substrate being cell-assembled by a sealant, the sealant being located at a position between a sealant region of the color filter substrate and a sealant region of the array substrate, and the sealant being nontransparent after curing.

10. The display device according to claim 8, further comprises: an array substrate cell-assembled with the color filter substrate, the color filter substrate and the array substrate being cell-assembled by a sealant, the sealant being located at a position between a sealant region of the color filter substrate and a sealant region of the array substrate, the sealant being transparent after curing, and a light-shielding body being arranged on a side of the sealant region of the color filter substrate away from the array substrate.

11. A manufacturing method of a color filter substrate, comprising:
coating a material film for forming a black light-shielding layer on a base substrate;
forming a pattern including the black light-shielding layer by a patterning process, the black light-shielding layer being arranged in at least one of regions except a sealant region of the color filter substrate.

12. The manufacturing method according to claim 11, wherein the regions except the sealant region of the color filter substrate comprise: a display region and an edge region.

13. The manufacturing method according to claim 11, wherein the black light-shielding layer is arranged in the display region or the edge region.

14. The manufacturing method according to claim 11, wherein the black light-shielding layer is arranged in both the display region and the edge region.

15. The manufacturing method according to claim 14, wherein the black light-shielding layer includes a first black light-shielding pattern and a second black light-shielding pattern, the first black light-shielding pattern is arranged in the display region, and the second black light-shielding pattern is arranged in the edge region.

16. A manufacturing method of a display device, comprising the manufacturing method of the color filter substrate according to claim 11.

17. The manufacturing method according to claim 16, further comprising:
providing an array substrate;
cell-assembling the color filter substrate and the array substrate by a sealant, wherein, the sealant is located at a position between a sealant region of the color filter substrate and a sealant region of the array substrate;
curing the sealant by irradiating the sealant with light passing the sealant region of the color filter substrate; or, curing the sealant by irradiating the sealant with both light passing the sealant region of the color filter substrate and light passing the sealant region of the array substrate.

18. The manufacturing method according to claim 17, wherein under a condition that the sealant is transparent, after curing the sealant, the method further comprises:
arranging a light-shielding body on a side of the sealant region of the color filter substrate away from the array substrate.
